(19) United States
(12) Patent Application Publication
(10) Pub. No.: US 2011/0060684 A1
(43) Pub. Date: Mar. 10, 2011

(54) Machine, program product, and computer-implemented methods for confirming a mobile banking request

(76) Inventors: Scott J. Jucht, Sioux Falls, SD (US); Trent Sorbe, Brookings, SD (US)

(21) Appl. No.: 12/731,852

(22) Filed: Mar. 25, 2010

Related U.S. Application Data
(60) Provisional application No. 61/163,316, filed on Mar. 25, 2009.

(51) Int. Cl. G06Q 40/00

(52) U.S. Cl. 705/42

(57) ABSTRACT

Embodiments of the present invention include methods, program product and machines for providing a confirmation for a mobile banking request, e.g., a funds movement request, originating via a text message utilizing a predetermined communications protocol, e.g., Short Message Service (SMS). A customer sends and a bank server receives a request originating via text message. The text message can include an amount and identifiers for accounts to be debited and credited. The bank server accesses an account responsive to a phone number associated with the text message. The bank server stores the request as pending. The bank server sends a verification request via text message to the customer and then receives a verification response via text message from the customer. The verification request can include a one-time verification code required for a valid verification response. Next, the bank server authorizes the pending request responsive to a valid verification response.

This application claims priority and benefit to U.S. Provisional Patent Application No. 61/163,316 titled “ System, Program Product, and Methods for Confirming a Mobile Banking Request ” filed on Mar. 25, 2009, and which is incorporated herein by reference in its entirety.

### BACKGROUND

1. Technical Field

The present invention relates generally to the financial service and banking industries, and, more particularly, to machines, program products, and associated computer-implemented methods for enabling movement of funds from a bank account to a payee after a request verification using text messaging for mobile banking.

2. Background Information

As the banking industry develops from face-to-face interactions, e.g., between customer and banker, to online actions, e.g., over the Internet or World Wide Web, to mobile transactions, e.g., using mobile telephones, improvements and enhancements in security schemes and protections are needed. Mobile banking is a term used for performing balance checks, account transactions, payments, person-to-person payments, and other functions via a mobile device such as a mobile phone or a personal digital assistant (PDA) utilizing Short Message Service (SMS) or other communication protocols as understood by those skilled in the art. Short Message Service (SMS) is a communication service that uses standardized communications protocols and allows the interchange of short text messages between mobile telephone devices. Under SMS, text messages are limited to 1120 bits. Using the default Global System for Mobile communications 7-bit alphabet, the 1120-bit limit results in 160 7-bit characters as understood by those skilled in the art. Alternately, using an 8-bit data alphabet, the 1120-bit limit results in 140 8-bit characters; using a 16-bit alphabet, including, 16-bit Unicode Transformation Format, the 1120-bit limit results in 170 16-bit characters as understood by those skilled in the art. SMS is standardized in the Global System for Mobile communications (GSM), the most popular standard for mobile phones in the world. SMS is also available with non-GSM mobile communications systems. SMS is also known more generally as text messaging, and an individual SMS message is known as a text message.

Online banking utilizes client-server architecture. Such online, e.g., Internet, banking often utilizes computer systems, servers, databases, and other back-office infrastructure (the server portion of the architecture) to support the business processes, store information and data, and communicate with the access devices, e.g., computers. Online banking also employs security protocols, for example a personal computer using the Internet to access a banking system can utilize various well developed security schemes and protections, such as firewalls, encryption, authentication, secure socket layers, virtual private networks and tunnels, anti-virus systems, and event monitoring systems. The security schemes and protections used by a personal computer for online banking may not be available or practical in a mobile banking environment, e.g., a mobile phone or a personal digital assistant (PDA) environment utilizing text messaging, due to limitations in the communications protocols used or limitations in the access devices. Moreover, a mobile banking application would diverge from an online bank with respect to the client portion of the architecture, including the communications protocols used between client and server. As a result, mobile banking has unique security risks and needs.

Text message spoofing, e.g., SMS spoofing, is known and involves setting whom a text message appears to come from by replacing the originating mobile number with alphanumeric text. While text message spoofing, e.g., SMS spoofing, has legitimate uses (including setting the company name from which the message is being sent), known illegitimate uses (such as impersonating another person, company, or mobile device) raise security concerns for numerous industries, including mobile banking. Currently, many mobile carriers generally do not permit funds transfers via SMS as a best practice due to spoofing and other security concerns.

### SUMMARY OF INVENTION

In view of the foregoing, Applicants have recognized a need for enhanced security machines, computer program products, and computer-implemented methods for the mobile banking industry. In particular, Applicants recognize a need to confirm a mobile banking request, e.g., a funds movement request or a payment request, originated via a communications protocol for exchanging short text messages with mobile telephone devices, e.g., a SMS message. Accordingly, the present invention provides embodiments of machines, program products, and associated methods for confirming a mobile banking request, including providing fund movement request confirmation.

Embodiments of the present invention include, for example, a bank server receiving a mobile banking request, e.g., a funds movement request, using a communications protocol for exchanging short text messages with mobile telephone devices, e.g., a SMS message. For example, Short Message Service (SMS) text message from a customer mobile device, e.g., a mobile telephone. The bank server stores the request as pending and sends a verification request to the customer mobile device. In an exemplary embodiment, the verification request can include a one-time verification code and direct the customer to send the code to confirm the mobile banking request. The bank server then receives a verification response, e.g., a “YES” message or a one-time verification code. If the verification response is valid, the bank server executes the pending request, i.e., transfers the funds for a funds movement request. According to embodiments of the present invention, a cancellation of the mobile banking request can result from, for example, an instruction from the customer; an unknown or improper account identifier; an invalid verification response due to a time out, an incorrect verification response (including message or one-time code), or an unacceptable number of mismatched attempts.

Other features of the embodiments of the present invention include, for example, the bank server sending a confirmation notification via a text message, e.g., a SMS message, to present a visual representation of the satisfied request, e.g., the funds movement. Other embodiments include the use of prepaid card, deposit accounts, and pre-approved line of credit accounts.

The benefits of the embodiments of the present invention include enhancements of security for mobile banking, allowing a more-secure expansion of banking services through mobile devices, including, for example, person-to-person payments. The benefits of the embodiments include no unencrypted account numbers being sent in text messages; instead pre-configured identifiers are used. Advantageously, the mobile device does not store account numbers. According to embodiments of the present invention, no session initiation or termination is required; no username and password are required for mobile banking applications. The benefits of the embodiments include configurable retries and time outs. The benefits of the embodiments include various notifications and confirmations to thwart spoofing and other security concerns and keep the customer informed.

Embodiments of the present invention include a machine to provide confirmation of a mobile banking request, e.g., a funds movement request. The machine includes a computer server associated with a bank defining a bank server. The bank server has memory and is positioned to send and receive text messages utilizing a communications protocol for exchanging short text messages with mobile telephone devices, e.g., Short Message Service. In addition, the memory of the bank server can include, for example, a computer program product as described herein.

The computer program product, according to an embodiment of the present invention, is stored in one or more tangible computer memory media and is operable on a computer. The computer program product includes a set of instructions that, when executed by the computer, cause the computer to perform various operations. The operations can include receiving a mobile banking request originating via a text message utilizing, e.g., Short Message Service. The text message has header data, including a phone number of an originating device. The operations can include storing the mobile banking request as pending. The operations can include sending to the phone number a verification request via a text message, e.g., a Short Message Service message, and receiving a verification response via a text message responsive to the verification request. The operations can include executing the mobile banking request, e.g., a funds movement request, responsive to a valid verification response so that the request is no longer pending.

Embodiments of the present invention include a computer-implemented method of providing confirmation of a mobile banking request, e.g., a funds movement request. The computer-implemented method can include receiving by a bank server a mobile banking request originating via a text message utilizing a communications protocol for exchanging short text messages with mobile telephone devices, e.g., Short Message Service. The text message has header data, including a phone number of an originating device. The computer-implemented method can include storing the mobile banking request as pending by the bank server. The computer-implemented method can include sending to the phone number a verification request and receiving by the bank server a verification response responsive to the verification request. The computer-implemented method can include the bank server executing the mobile banking request, e.g., a funds movement request, responsive to a valid verification response so that the request is no longer pending.

Embodiments of the present invention, including computer-implemented methods, machines, and computer program products, also allow the combining of product enhancements with other complimentary enhancements and can continue to provide significantly improved services and products to expand mobile banking in a secure manner.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a front plan view of a mobile phone device, including a display screen displaying a text message, according to an embodiment of the present invention;

FIG. 2 is a set of example text messages according to an embodiment of the present invention;

FIG. 3 is a schematic block diagram of a machine to provide fund movement confirmation according to an embodiment of the present invention;

FIG. 4 is a schematic flow diagram of a computer-implemented method of providing fund movement confirmation according to an embodiment of the present invention;

FIGS. 5A and 5B are respective front and back plan views of a prepaid card according to an embodiment of the present invention;

FIG. 6 is a schematic block diagram of a point-of-sale hardware device according to an embodiment of the present invention;

FIG. 7 is a schematic block diagram of a machine to provide fund movement confirmation according to an embodiment of the present invention;

FIG. 8 is a schematic block diagram illustrating an exemplary database construction of a funds movement request data file for a machine to provide fund movement confirmation according to an embodiment of the present invention;

FIG. 9 is a schematic diagram of a computer server having program product stored in memory thereof according to an embodiment of the present invention;

FIG. 10 is a front plan view of a display screen of a computer displaying an excerpt of an account activity statement according to an embodiment of the present invention;

FIG. 11 is a front plan view of a display screen of a computer displaying an excerpt of a customer account interface for pre-configuring a customer account according to an embodiment of the present invention;

FIG. 12 is a schematic block diagram of a machine to provide fund movement confirmation for a draw from a pre-approved line of credit according to an embodiment of the present invention; and

FIG. 13 is a schematic block diagram of a machine to provide confirmation for mobile banking request according to an embodiment of the present invention.

### DETAILED DESCRIPTION OF INVENTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

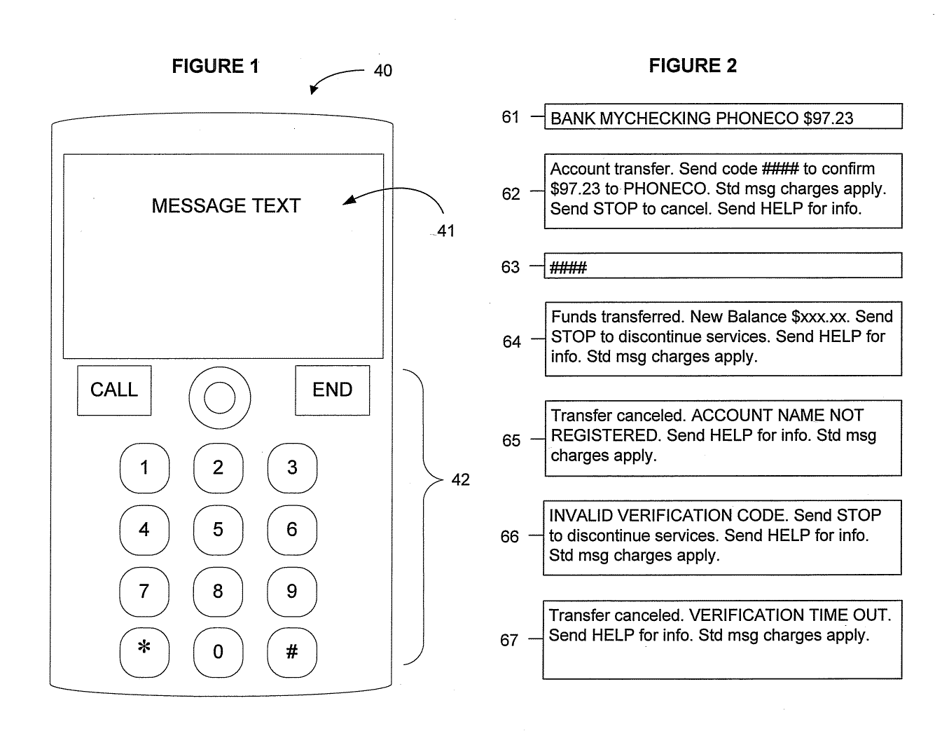

As illustrated in FIGS. 1-11, embodiments of machine 80, computer program products 221, and methods 100 of the present invention can provide enhanced security for mobile banking using a communications protocol for exchanging short text messages with mobile telephone devices, e.g., Short Message Service (SMS) text messages, including confirmation for a funds movement request. A funds movement request involves a request to move of funds from one account to another, i.e., a payee, including a bill payment, a person-to-person payment, a transfer associated with exercising a line of credit, and other transfers of funds, payments, conveyances, and exchanges as understood by those skilled in the art.

As illustrated in FIG. 1, a customer mobile device 40, such as, a mobile phone, can include a display 41 for originating, i.e., composing and sending, text messages and also receiving text messages for mobile banking. The customer can use input/output (I/O) devices 42, e.g., a keyboard, for the mobile device 40 to enter a message or otherwise interact with the device. Other embodiments include using a personal digital assistant (PDA) for mobile banking. Because mobile devices that use SMS protocols are known in the art, these devices will not be described in detail, other that the relationship between the mobile devices and the machine, program product and computer-implemented methods of the instant invention.

Example text messages, as illustrated in FIG. 2, include messages between the customer and a bank server. A customer can send, for example, a funds movement request 61 to the bank server with an exemplary format of “<action code><debit account><credit account><amount>,” resulting in the text of the text message being “BANK MYCHECKING PHONECO $97.23.” In this example 61, the action code for funds movement request is “BANK.” In this example 61, “MYCHECKING” is a first identifier for an account to be debited, and “PHONECO” is a second identifier for an account to be credited. In this example 61, “$97.23” is an amount of funds to be moved. Embodiments of the present invention include other action codes, account identifiers, and amounts as understood by those skilled in the art.

In response to a funds movement request 61, a bank server can send to the customer, for example, a verification request 62. In this example 62, the verification request states: “Account Transfer. Send code #### to confirm $97.23 to PHONECO. Std msg charges apply. Send STOP to cancel. Send HELP for info.” That is, the verification request 62 can indicate to the customer that a funds movement request has been received and can include a one-time verification code. As understood by those skilled in the art, details of the funds movement request, such as, the account to be debited in this example, can be omitted for security purposes; details can also be included, such as, the amount and the account to be credited in this example, to identify sufficiently the funds movement request and to reinforce against any later repudiation by the customer. Also, if the original funds movement request 61 is fraudulent, the customer can cancel the pending request through another text message, e.g., a “STOP” message. In this application, “Std msg” means “standard message.” Other boilerplate or instructions can be included as understood by those skilled in the art.

In response to the verification request 62, the customer can send to the bank server, for example, a verification response 63. The verification response can include the one-time verification code, such as, “####,” generated for funds movement request and sent to the customer in the verification request 62.

In response to a valid verification response 63, the bank server can send to the customer, for example, a confirmation notification 64, including additional data, such as, a new balance of the debited account.

In addition, embodiments of the present invention can include, for example, numerous error messages. For example, if the funds transfer request 61 includes an improper, invalid, unknown, unused, or expired account identifier, the bank server can cancel the request and provide a cancellation notice as shown in 65. For example, if the verification response includes an invalid verification code, i.e., a verification code that does not match the verification code included in the verification request, the bank server can provide a notification message as shown in 66. In embodiments of the present invention that allow retry attempts, the notification message can prompt for a retry attempt, expressly or indirectly, and can include, for example, a number of invalid attempts, retry attempts remaining, or both as understood by those skilled in the art. In addition, in the absence of a valid verification response within a preselected time period resulting in a time out, for example, the bank server can cancel the request and provide a cancellation notice as shown in 67.

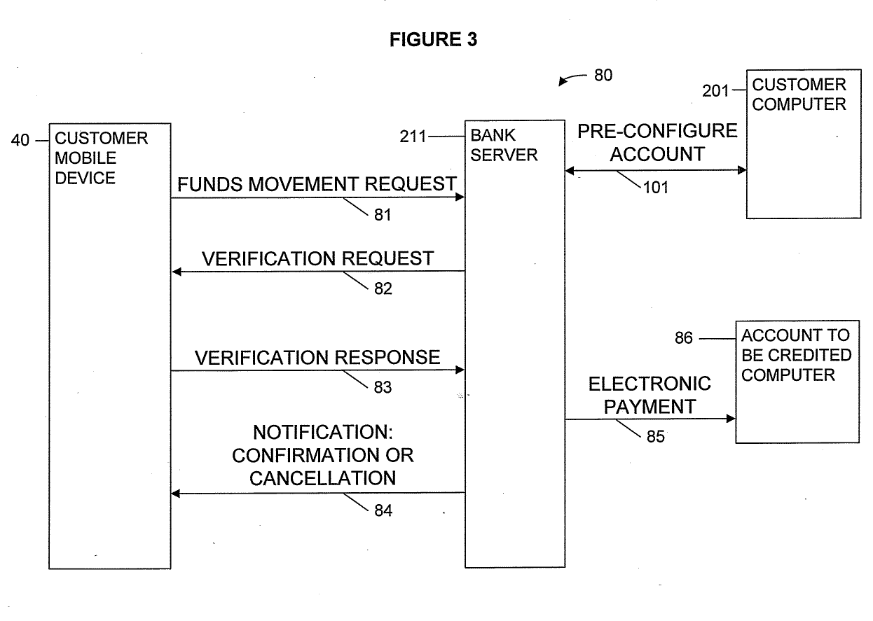

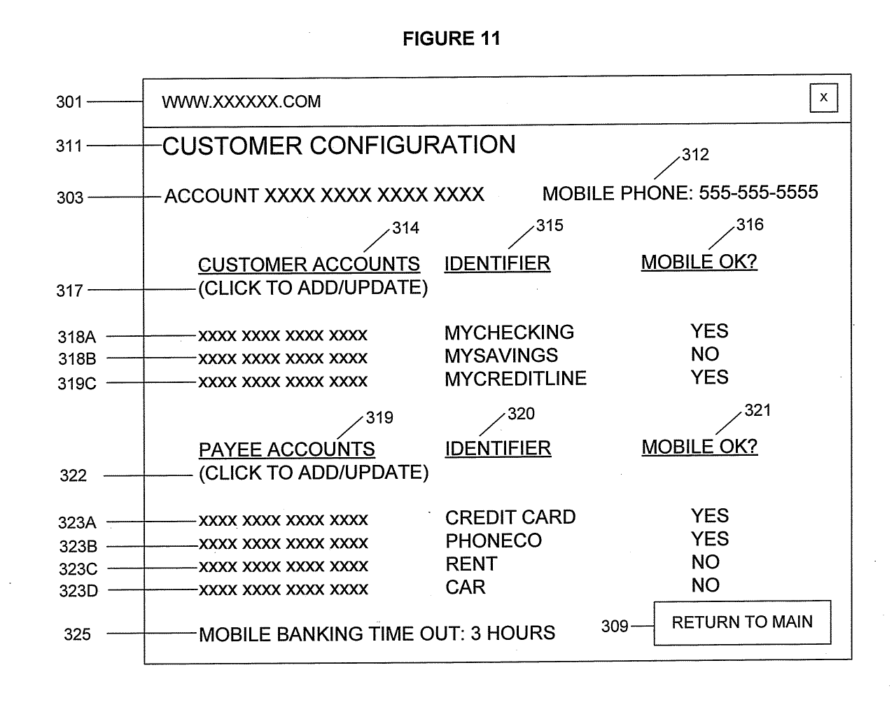

As illustrated in FIG. 3, embodiments of a machine 80 according to the present invention can include a customer mobile device 40 and bank server 211 exchanging a series of text messages. In addition, the machine 80 can include, for example, a customer computer 201 for communicating with the bank server to pre-configure the customer account, i.e., to allow the customer to provide custom identifiers so that the a customer conveniently does not need to know account numbers, including any routing numbers as necessary, for a funds movement request. (See also FIG. 11.) Advantageously, the use of custom identifiers instead of account numbers provides additional security in that identifiers can be changed if compromised and can expire after a predetermined time or number of transfers. In addition, pre-configuring the customer account 101 can include associating a mobile phone number with a customer account so that the bank server 211 can identify an incoming text message with an account through the text message header. The machine 80 can include a funds movement request 81 from the customer mobile device 40 to the bank server 211. In response, the bank server 211 can send to the customer mobile device 40 a verification request 82. In one embodiment, the verification request 82 can notify the customer of the funds movement request 81 and direct the customer to send a “YES” to confirm the transaction. In a preferred embodiment, the verification request can include a one-time verification code and direct the customer to send the code to confirm the transaction. In response to the verification request 82, the customer mobile device 40 can send to the bank server 211 a verification response 83, e.g., a “YES” message or a one-time verification code. (See, e.g., 63 in FIG. 2.) The funds movement request 81 being verified through the verification request 82 sent by the bank server 211 and verification response 83 received by the bank server 211, the bank sever 211 completes the funds movement. In one embodiment, the bank server 211 makes an electronic payment 85 to the computer associated account to be credited 86. Embodiments of electronic payments include, for example, wire transfers, ACH payments, deposits made to prepaid cards, and other forms of intrabank or interbank transfers, as understood by those skilled in the art. Automated Clearing House (ACH) is the name of an electronic network for financial transactions in the United States, regulated by the Federal Reserve, as understood by those skilled in the art. In another embodiment, the funds movement is an intrabank process as understood by those skilled in the art. The machine 80 can include, for example, a notification to the customer mobile device 40 of a confirmation or cancellation of the funds movement request 84, as appropriate, to thereby present a visual representation of the funds movement. See also, e.g., FIG. 2 for example confirmation and cancellation notifications.

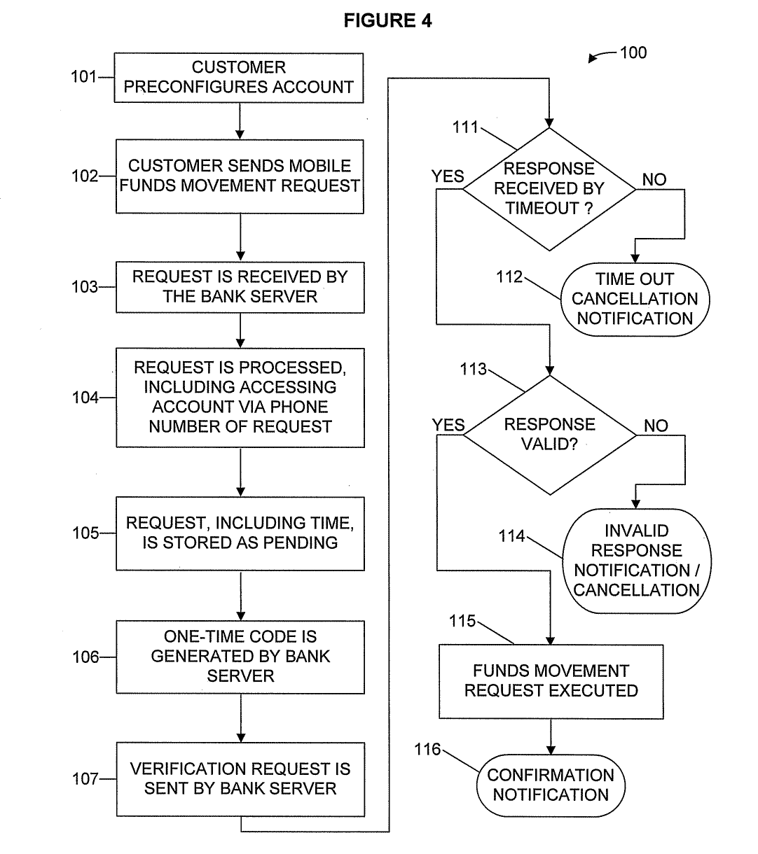

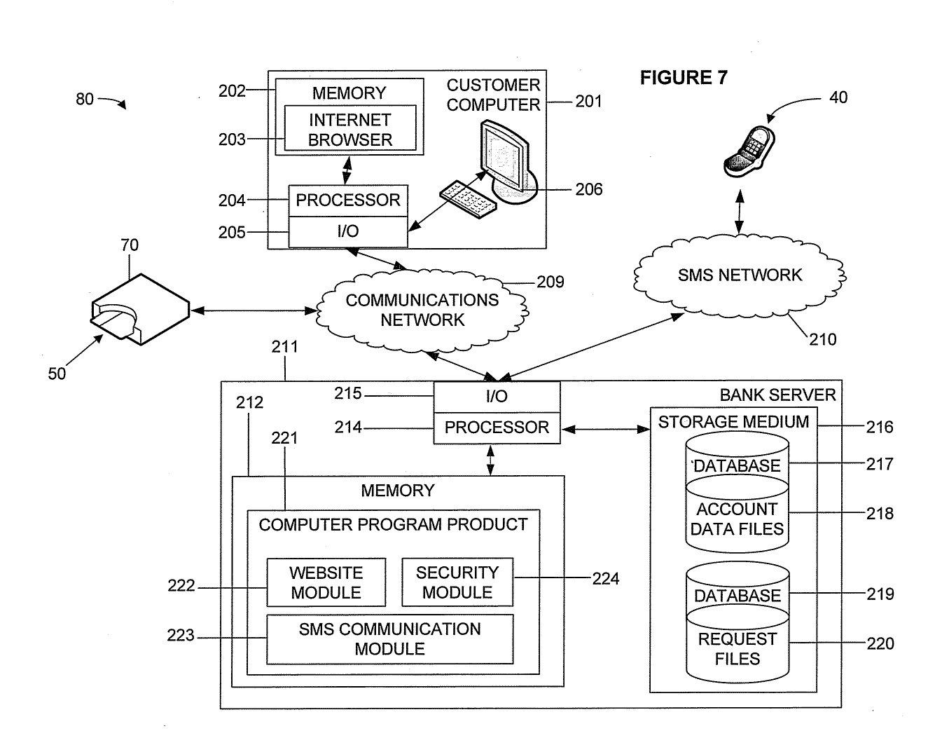

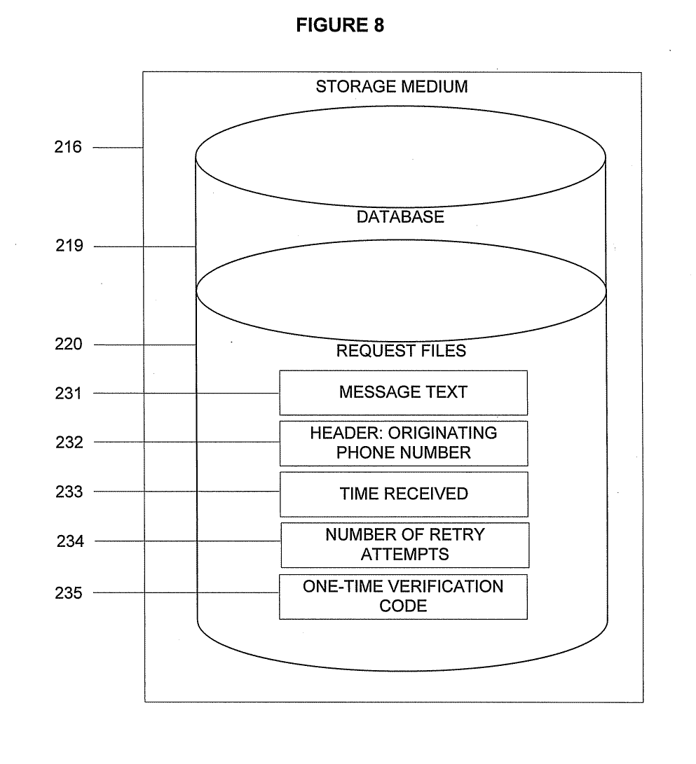

As illustrated in FIG. 4, embodiments provide, for example, a computer-implemented method of providing fund movement confirmation 100. The computer-implemented method 100 can include a customer pre-configuring an account 101 through a customer computer 201. See also FIGS. 7 and 11. The computer-implemented method 100 can include a customer sending a mobile funds movement request 102. The computer-implemented method 100 can include a bank server 211 receiving a funds movement request 103 originating via a text message utilizing a predetermined communications protocol for exchanging messages with mobile telephone devices, e.g., Short Message Service. As illustrated in example 61 in FIG. 2, the funds movement request can include a first identifier for an account to be debited defining a debit account, a second identifier for an account to be credited defining a credit account, and an amount. The text message containing the funds movement request includes header data, as understood by those skilled in the art. The header data can include, for example, a phone number of an originating device. The computer-implemented method 100 can include the bank server 211 processing the request, including accessing a customer account responsive to the phone number of the originating device 104. As understood by those skilled in the art, processing the request can include rejecting requests using improper, invalid, unknown, unused, or expired account identifiers. See, e.g., 65 in FIG. 2. The computer-implemented method 100 can include the bank server 211 storing the funds movement request 105 so that the funds movement is pending a confirmation of the request. See, e.g., FIG. 8. Storing the funds movement request can include assigning a first time for the receiving of the funds movement request 103 by the bank server 211 as understood by those skilled in the art. The computer-implemented method 100 can include the bank server 211 generating a one-time verification code 235 for the stored funds movement request 106. The computer-implemented method 100 can include the bank server 211 sending to the phone number of the customer mobile device 40 a verification request 107 via a text message, e.g., a Short Message Service message. The computer-implemented method 100 can include the bank server 211 receiving, at a second time, a verification response 83 via a text message utilizing a predetermined communications protocol for exchanging messages with mobile telephone devices, e.g., Short Message Service, responsive to the verification request 82. The computer-implemented method 100 can include the bank server 211 determining whether the second time is within a preselected time period beginning with the first time 111 so that a verification response received after the preselected time period is untimely and invalid. See also 325 in FIG. 11. In the absence of a valid verification response within a preselected time period resulting in a time out, for example, the bank server 211 can cancel the request and provide a time out cancellation notification 112. See, e.g., 67 in FIG. 2. Responsive to a timely verification response 83, the computer-implemented method 100 can include the bank server 211 determining if the verification response is valid 113. For example, if the embodiment requires the verification response to include a second one-time verification code, the bank server 211 can determine whether the first one-time verification code matches the second one-time verification code to thereby confirm that the code sent by the bank server in the verification request matches the code received by the bank server in the verification response. The computer-implemented method 100 can include the bank server 211 sending an invalid response or cancellation notification 114 if the verification response is not valid. As understood by those skilled in the art, an invalid response notification 114 can, expressly or indirectly, prompt for a retry attempt in embodiments of the present invention that allow retry attempts. The computer-implemented method 100 can include the bank server 211 cancelling the funds movement request after a predetermined number of attempts. If the verification response is valid, the computer-implemented method 100 can include the bank server 211 authorizing the stored funds movement request. The funds movement request is executed 115 by the bank server 211; funds are transferred from the debit account to the credit account so that funds movement request is no longer pending. Next, the computer-implemented method 100 can include the bank server 211 sending a confirmation notification 116 to the phone number via a text message utilizing Short Message Service to thereby present a visual representation of the funds movement. See, e.g., 64 in FIG. 2.

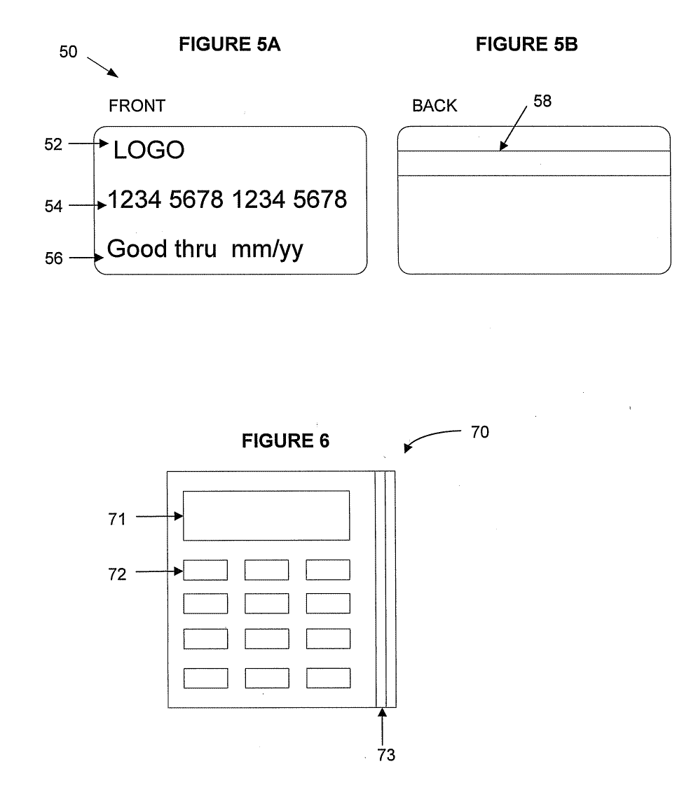

As illustrated in FIGS. 5A, 5B, 6, and 7, embodiments of the present invention can include, for example, a prepaid card 50 and a card reader 70 device. As understood by those skilled in the art, a prepaid card can have indicia 54, e.g., logos, slogans, source identifiers, of a sponsoring bank and of a prepaid card processor; a serial number 52; and expiration date 56. The structures of various types of specific cards, e.g., magnetic stripe 58, type of material, are well known to those skilled in the art and can be used with embodiments of the present invention. Typically, a card 50 is formed from plastic and has a magnetic stripe 58 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or receiving cards already formed. The magnetic stripe card 50 can store information, or data, e.g., account information, by modifying the magnetism of particles on the magnetic stripe 58 on the card. The data can be read by swiping the card through a slot 73 past a reading head of a card reader device 70, including most point-of-sale hardware. The reader 70 can include a display 71 and input/output (I/O) devices 72, e.g., a keypad. Typically, there are two tracks of data on a magnetic card used for financial transactions, known as tracks 1 and 2. In addition, a third track known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number (including a Bank Identification Number as understood by those skilled in the art), an expiration date, a service code, and discretionary verification data, such as, a Personal Identification Number, or PIN. The data on the card can be used, for example, to facilitate a transaction. For example, when the card 50 is swiped through a reader 70, the data on the magnetic stripe 58 is read and processed by the reader 70. The reader 70 can then communicate through an electronic communications network 209 to, for example, a prepaid card processor or a bank server 211. The card reader 70, e.g., point of sale, communicates the account data as read from the card, as well as other data, such as, an amount of a proposed transaction for approval. The other data, for example, can be entered by merchant personnel (e.g., an amount of the transaction), the consumer (e.g., a PIN, or security code), or bank personnel (e.g., a security approval). The prepaid card processor or bank server 211 can then utilize the account information and other information or data to authorize or reject a purchase by, for example, determining whether a proposed purchase by the consumer is less than an amount of funds remaining on the card. Moreover, optional security measures, including, for example, a mismatch between a PIN supplied by the consumer and a PIN stored on the card or in a database, can result in the rejection of a proposed transaction. The prepaid card processor or bank server 211 then perform certain functions, including responding to the authorization request so that a point-of-sale displays an indication of approval or rejection, resulting in a visual depiction to a merchant of the approval or rejection of the proposed transaction. Also, prepaid card processor 72, 76 can, for example, write data to a database to record a transaction, to debit available funds from an account associated with the prepaid card 50, and to credit directly or indirectly a merchant for a purchase. In addition to purchase authorization, embodiments of the present invention also can include customer inquiries into recent transactions or a balance inquiry, i.e., an amount of remaining value associated with the prepaid card.

Embodiments of the present invention can include, for example, a funds movement request wherein the debit account is a prepaid card account or a deposit account. Embodiments of the present invention can include, for example, a funds movement request wherein the credit account is a prepaid card account or a deposit account. That is, embodiments of the present invention include the authorization of loading a value onto a prepaid card responsive to the funds movement request to thereby convert a card into a prepaid card having an associated value and being capable of purchasing goods. A deposit account, also known as, for example, a checking account, a demand account, demand deposit account, negotiable order of withdrawal (NOW) account, or other similar account, is an account held at a bank or other financial institution wherein the money deposited in the account is available on demand through various means, including checks, debit cards, bill payment services, check cards, wire transfers, and others as understood by those skilled in the art.

As illustrated in FIG. 7, the machine 80 can include, for example, a customer computer 201 used to access a communications network 209, including, for example, the Internet and the World Wide Web. The customer computer 201 can include, for example, a display 206; memory 202, such as, computer readable media; one or more processors 205, and input-output I/O devices 205. The memory 202 of the customer computer 201 can include an Internet browser 203, a computer application used for accessing sites or information on a network. The customer computer 201 can be used to pre-configure the customer account. See also FIGS. 3 and 11. The machine can also include, for example, a customer mobile device 40, such as, a mobile phone, for originating, i.e., composing and sending, text messages and also receiving text messages for mobile banking according to embodiments of the present invention. See also FIGS. 1 and 3. The machine 80 can include, for example, a card reader 70 for reading prepaid cards and communicating through the electronic communications network 209 with the bank server 211, so that a card is converted into a prepaid card having an associated value and being capable of purchasing goods. See also FIGS. 5A, 5B, and 6. The machine 80 can further include, for example, a bank server 211 according to embodiments of the present invention, and the bank server 211 may have integrated therein or is connected to a storage medium 216, communication interface 209 and an SMS network 210.

The storage medium 216 can be used to store customer account and request information in separate records, tables, or columns in an associated database, which may be received from the communications network 209 or SMS network 210. As is understood in the art, the storage medium 216 includes a processor directing data from a bus into the database memory, which can be e.g., a hard drive, optical storage or the like, and computer software that provides each of the plurality of issuer component computers (not shown), including the bank server 211, access the data therein

FIG. 8 shows an exemplary database structure for customer data stored in storage medium 216, though one skilled in the art will appreciate other database structures are possible and are included within the scope of the invention. As illustrated in FIG. 8, the funds movement request table 220 can include, for example, a message text 231 including header data, an originating phone number 232; a time received 233; a number of retry attempts 234; and a one-tie verification code 235, generated specifically for the request. Database 219 may also include a customer account table, and a payee table. The customer account table may include includes columns, i.e., fields for data entry, such as, e.g., a customer account number, a customer name, a customer address, a customer email address, a customer telephone number and a customer's transfer history. The payee table may include columns for e.g., a customer account number with the payee, a transaction amount, a payee name, a payee address, a payee email address, and a payee telephone number. As one skilled in the art will appreciated, each of these tables may include dependent tables for each of the columns, e.g., the address column for the customer account table or payee table may be implemented as another table with separate columns for the street, state, and zip code for each customer account and each product provider. Moreover, database 1500 may include fewer or more data tables and columns depending upon the implementation of the particular embodiment of the invention. Those skilled in the art will understand and recognize that multiple transfer requests, and a customers' personal information can also be included in the database tables and columns, and that storage medium 216 can be implemented as a single computer, server, plurality of computers or servers, or as separate component of the bank server 211.

As shown in FIGS. 7 communication interface 209 allows a customer computer 201, mobile device 40 and card reader 70 to connect to the bank server using, e.g., a telephone line, or web server [not shown] integrated with or in connection with the bank server 211. The web server [not shown] is used to manage computer traffic into and away from the bank server 211. As such, web server [not shown] may be configured with processors, memory, and I/O devices to allow efficient exchange of data between the bank server 211, its related components, the customer computer 201, the mobile device 40, and the card slot reader 70 to facilitate the web functions thereof.

Bank server 211 can be configured as a computer, a server, or a machine of distributed computers or server that at least include memory 212, program product 221, processor 214, input/output device and (“I/O”) 215, as shown in FIG. 7. I/O device 215 connects the bank server 211 to, storage medium 216, communication interface 209, and web server [not shown], to thereby allow bank server 211 to send and receive order data. I/O device 215 can be any I/O device including, but not limited to a network card/controller connected by a PCI bus to the motherboard, or hardware built into the motherboard of the bank server 211 to connect same to the network.

As can be seen, the I/O device 215 is connected to the processor 214. Processor 214 is the “brains” of the bank server 211, and as such executes program product 221 and works in conjunction with the I/O device 215 to direct data to memory 212 and to send data from memory 212 to the storage medium 216, communication interface 209, and web server [not shown]. Processor 214 can be any commercially available processor, or plurality of processors, adapted for use for the bank server 211, e.g., Intel® Xeon® multicore processors, Intel® micro-architecture Nehalem, AMD Opteron™ multicore processors, etc. As one skilled in the art will appreciate, processor 214 may also include components that allow the bank server 211 to be connected to a display [not shown] and keyboard that would allow a user to directly access the processor 214 and memory.

Memory 212 stores instructions for execution on the processor 214, and consists of both non-volatile memory, e.g., hard disks, flash memory, optical disks, and the like, and volatile memory, e.g., SRAM, DRAM, SDRAM, etc., as required to process embodiments of the instant invention. As one skilled in the art will appreciate, though memory 212 is depicted on, e.g., the motherboard, of the bank server 211, memory 212 may also be a separate component or device, e.g., FLASH memory, connected to the bank server 211. Memory 212 may also store applications that various workstations can access and run on the bank server 211. Importantly, memory 212 stores the program product 221 of the instant invention. As one skilled in the art will understand, the program product 221, along with one or more databases/tables/fields/records for customer electronic order card data and associated customer account data, transfer requests 220 and payee data, can be stored either in memory 212 or in separate memory associated, for example, with a storage medium 216, positioned in communication with the bank server 211.

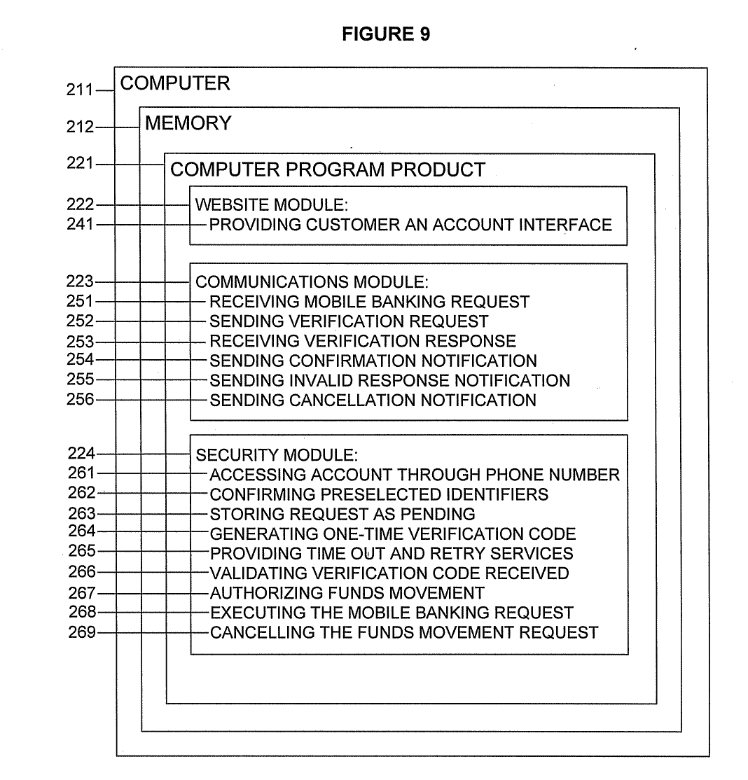

The program product 221 can be configured to process the received transfer request and is described in more detail in reference to FIGS. 7 and 9. The computer program product 211 is associated with a bank server 211, is stored in one or more tangible computer memory media 221, and is operable on a computer. The computer program product includes a set of instructions that, when executed by the computer, cause the computer to perform various operations. The operations can be organized in various modules and components.

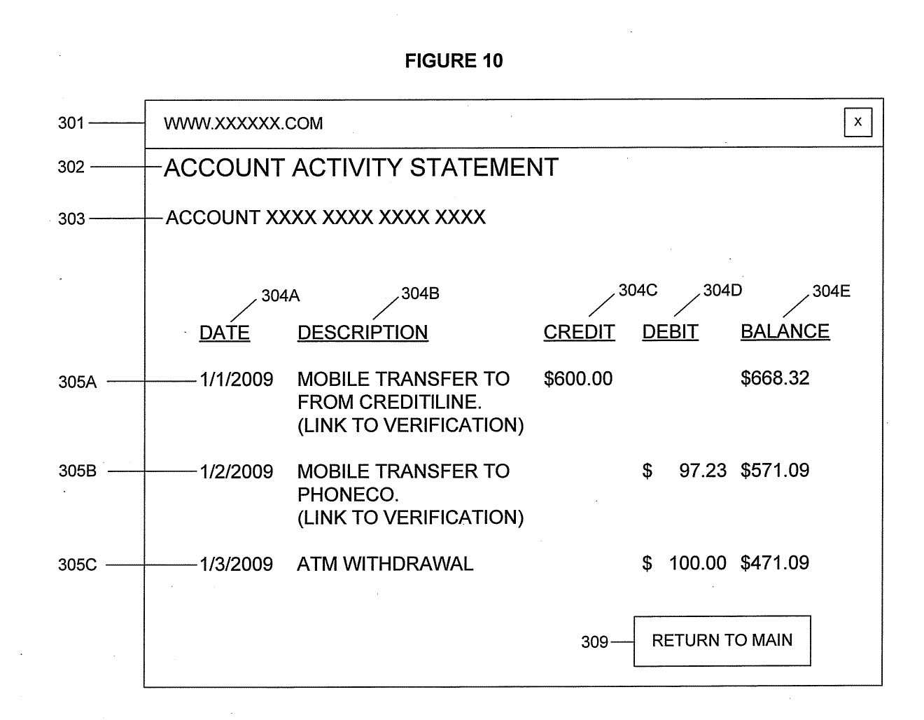

The computer program product 221 can include, for example, a website module 222, for providing the customer an account interface for pre-configuring a customer account, including generating content for web pages, e.g., for customer-specific web pages. See, e.g., FIGS. 10 and 11. Pre-configuring a customer account can include, for example, associating a mobile phone number 312 with a customer account 303. Pre-configuring a customer account can also include, for example, associating an identifier 315, 320 with a debit account (typically but not limited to a customer account 314) and an identifier 315, 320 with a credit account (typically but not limited to a payee account 319) so that the funds movement request does not use account numbers.

The computer program product 221 can include, for example, a communication module 222, for sending and receiving text messages utilizing a predetermined communications protocol for exchanging messages with mobile telephone devices, e.g., Short Message Service. The communication module 222 can, for example, receive a mobile banking request 251, e.g., a funds movement request, and responsively send a verification request 252. The communication module 222 can also, for example, receive a verification response 253 and, as appropriate, send a confirmation notification 254, an invalid response notification 255, and a cancellation notification 256. See also, e.g., FIG. 2.

The computer program product 221 can include, for example, a security communication module 224. The security communication module 224 can include, for example, accessing a customer account responsive to phone number of the mobile device originating a funds movement request 261 and confirming the account within the funds movement request against preselected account identifiers 262. The security communication module 224 can include, for example, storing the funds movement request so that the funds movement is pending a confirmation of the request 263. The security communication module 224 can include, for example, generating a one-time verification code for the stored funds movement request 265 and determining whether the one-time verification code in the verification request matches the one-time verification code in the verification response to validate the verification code received 266. In addition, the security communication module 224 can include providing time out and retry services 265, such as, cancelling the funds movement request after a predetermined number of retry attempts 269. Also, the security communication module 224 can include assigning a first time for the receiving of the funds movement request and determining whether the second time is within a preselected time period beginning with the first time so that a verification response received after the preselected time period is untimely and invalid. The security communication module 224 can include authorizing the stored funds movement request from the debit account to the credit account responsive to the verification response so that funds movement request is no longer pending 267. The security communication module 224 can also include executing a mobile banking request responsive to the verification response so that the mobile banking request is no longer pending 268.

As illustrated in FIG. 10, embodiments of the present invention include, for example, converting text message data into a visual representation of account activity. For example, a customer computer 201, through an Internet Browser 203, can display an account activity statement 302 for a customer-specific account 303, or set of accounts, with each transaction including a date 304A, a description 304B, a amount credited to the account 304C, an amount debited from the account 304D, a resulting balance 304E, or other such data as understood by those skilled in the art. For example, the visual representation can include a funds movement request originating via a text message, including a message utilizing Short Message Service, which initiates a $600 draw from a pre-approved line of credit 305A. For example, the visual representation can include a funds movement request originating via a text message utilizing Short Message Service that executes a bill payment, e.g., a phone bill payment, 305B to thereby provide a representation of a purchase of goods, services, or both. In addition, the visual representation can include additional, non-mobile account activity as understood by those skilled in the art, such as, an Automated Teller Machine (ATM) withdrawal 305C.

As illustrated in FIGS. 11, embodiments of the present invention can include, for example, customer configuration 311 displays on a customer computer 201 communicating with the bank server 211 to pre-configure the customer account 303. See also FIGS. 3 and 7. Pre-configuration 101 allows the customer to provide custom identifiers 315, 320 for customer accounts 314, e.g., a customer checking account 318A, a customer savings account 318B, or a pre-approved line of credit account 318C, and for payee accounts 319, e.g., a credit card account 323A, an account for paying a phone company bill 323B, an account for paying rent 323C, or an account for making a car payment 323D, so that the a customer conveniently does not need to know account numbers, including any routing numbers as necessary, for a funds movement request. See, e.g., 61 in FIG. 2. Advantageously, the use of custom identifiers 315, 320 instead of account numbers provides additional security in that identifiers can be changed if compromised and can expire after a predetermined time or number of transfers. Also, pre-configuring the customer account 101 can include identifying whether an account can be accessed through a mobile banking funds movement request 316, 321. In addition, pre-configuring, the customer account 101 can include associating a mobile phone number 312 with a customer account so that the bank server 211 can identify an incoming text message with an account through the text message header. Also, pre-configuring the customer account 101 can include determining a mobile banking time out 325 as understood by those skilled in the art.

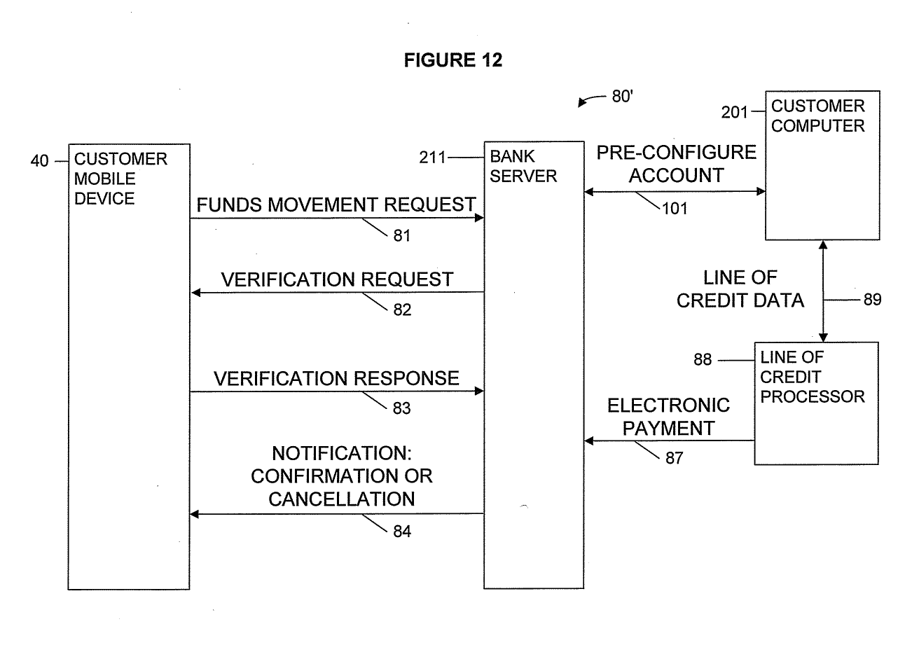

As illustrated in FIG. 12, embodiments of a machine 80′ according to the present invention can include a customer mobile device 40 and bank server 211 exchanging a series of text messages to provide fund movement confirmation for a draw from a pre-approved line of credit. The machine 80′ can include, for example, a customer computer 201 exchanging line of credit data 89 with a line of credit processor 88, associated with a lender. The customer computer 201 can supply applicant data, such as, identity information, employment history, direct deposit history, and other data as understood by those skilled in the art. The line or credit processor can supply provider and pre-approval data, such as, maximum credit limit information, rate and fee data, repayment schedules, and other information as understood by those skilled in the art. The machine 80′ can include, for example, a customer computer 201 for communicating with the bank server 211 to pre-configure the customer account 101. (See 319C in FIG. 11 for pre-configuring of a line of credit account.) The machine 80′ can include a funds movement request 81 from the customer mobile device 40 received by the bank server 211 to include a draw from a pre-approved line of credit. In response, the bank server 211 can send to the customer mobile device 40 a verification request 82. In response to the verification request 82, the customer mobile device 40 can send to the bank server 211 a verification response 83, e.g., a “YES” message or a one-time verification code. (See, e.g., 63 in FIG. 2.) The funds movement request 81 being verified through the verification request 82 sent by the bank server 211 and verification response 83 received by the bank server 211, the bank sever 211 completes the funds movement. The bank server 211 initiates a draw from the pre-approved line of credit via an electronic payment 87 from the line of credit processor 88. Embodiments of electronic payments include, for example, wire transfers, ACH payments, deposits made to prepaid cards, and other forms of intrabank or interbank transfers, as understood by those skilled in the art. The machine 80′ can include, for example, a notification to the customer mobile device 40 of a confirmation or cancellation of the funds movement request 84, as appropriate, to thereby present a visual representation of the funds movement. See also, e.g., FIG. 2 for example confirmation and cancellation notifications.

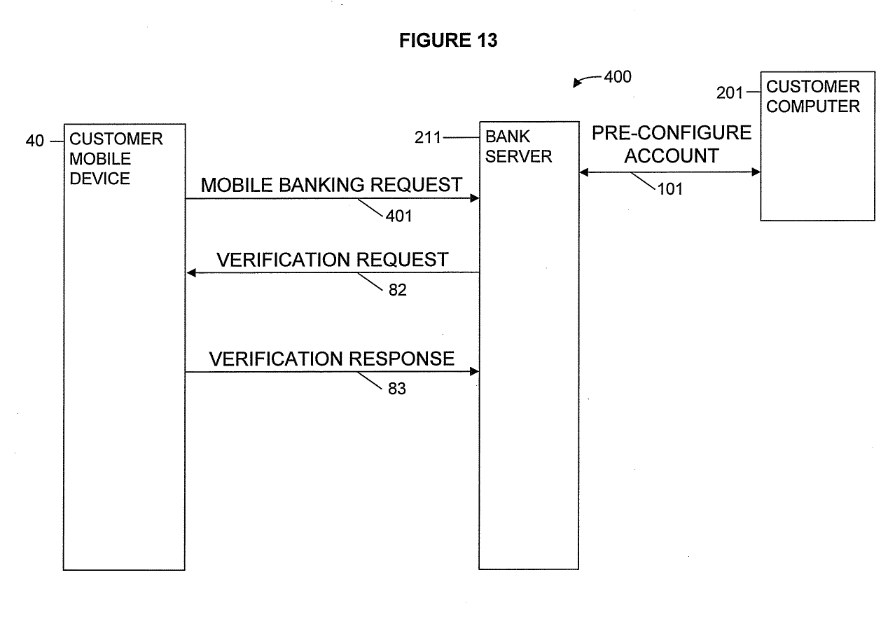

As illustrated in FIG. 13, embodiments of a machine 400 according to the present invention can include a customer mobile device 40 and bank server 211 exchanging a series of text messages to provide a general mobile banking request. The machine 400 can include a general mobile banking request 401 from the customer mobile device 40 received by the bank server 211. A general mobile banking request 401 can include but is not limited to a fund movement request, including account to account transfers, account to card transfers, and card to card transfers. A general mobile banking request 401 can include balance inquiry, transaction history, statement summary, account locking and unlocking, and other actions as understood by those skilled in the art. In response to the general mobile banking request, the bank server 211 can send to the customer mobile device 40 a verification request 82. In response to the verification request 82, the customer mobile device 40 can send to the bank server 211 a verification response 83, e.g., a “YES” message or a one-time verification code. (See, e.g., 63 in FIG. 2.) The general mobile banking request 401 being verified through the verification request 82 sent by the bank server 211 and verification response 83 received by the bank server 211, the bank sever 211 satisfies the request.

Embodiments of the present invention include a machine to provide confirmation of a mobile banking request. The machine includes a computer server associated with a bank defining a bank server 211. The bank server 211 has memory 212 and is positioned to send and receive text messages utilizing a predetermined communications protocol for exchanging messages with mobile telephone devices, e.g., Short Message Service. In addition, the memory 212 of the bank server 211 can include, for example, a computer program product 221. The computer program product is stored in one or more tangible computer memory media 212 and is operable on a computer. The computer program product 211 includes a set of instructions that, when executed by the computer, cause the computer to perform various operations. The operations can include receiving a mobile banking request originating via a text message 251, including utilizing Short Message Service. The text message has header data, including a phone number of an originating device. The operations can include storing the mobile banking request as pending 263. The operations can include sending to the phone number a verification request via a text message 252 and receiving a verification response via a text message responsive to the verification request 253. The operations can include executing the mobile banking request responsive to a valid verification response so that the request is no longer pending.

Embodiments of the present invention include a computer-implemented method of providing confirmation of a mobile banking request. The computer-implemented method can include receiving by a bank server 211 a mobile banking request originating via a text message utilizing a predetermined communications protocol for exchanging messages with mobile telephone devices 401, e.g., Short Message Service. The text message has header data, including a phone number of an originating device. The computer-implemented method can include storing the mobile banking request as pending by the bank server 211. The computer-implemented method can include sending to the phone number a verification request 82 and receiving by the bank server 211 a verification response 83 responsive to the verification request. The computer-implemented method can include the bank server 211 executing the mobile banking request responsive to a valid verification response so that the request is no longer pending.

The benefits of the embodiments of the present invention include enhancements of security for mobile banking, allowing a more-secure expansion of banking services through mobile devices. The benefits of the embodiments include no unencrypted account numbers being sent in text messages, e.g., SMS messages; instead pre-configured identifiers are used. Advantageously, the mobile device does not store account numbers. According to embodiments of the present invention, no session initiation or termination is required; no username and password are required for mobile banking applications. The benefits of the embodiments include configurable retries and time outs. The benefits of the embodiments include various notifications and confirmations to thwart spoofing and keep the customer informed.

A person having ordinary skill in the art will recognize that various types of memory are readable by a computer such as described herein, e.g., bank server, customer computer, computer server, prepaid card processors, line of credit processors, or other computers with embodiments of the present invention. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMS, DVD-R/RWs, DVD+R/RWs, flash drives, memory sticks, and other newer types of memories, and transmission type media such as digital and analog communication links. For example, such media can include operating instructions, as well as instructions related to the machine and the method steps described above and can operate on a computer. It will be understood by those skilled in the art that such media can be at other locations instead of or in addition to the locations described to store program products, e.g., including software, thereon. Each of these computer or servers, for example, can having one or more of these various types of memory as understood by those skilled in the art.

Many modifications and other embodiments of the invention will come to the mind of those skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A machine to allow a user to transfer money to an account using a mobile device, the machine comprising:
a computer server associated with a bank defining a bank server, the bank server having memory and being positioned to send and receive text messages utilizing Short Message Service;
computer program product associated with the bank server, stored in the memory, and operable on a computer, the computer program product comprising a set of instructions that, when executed by the computer, cause the computer to perform a process of confirming a funds movement request is valid and a process of executing the funds movement request, the instructions comprising the operations of:
matching the funds movement request, responsive to a text message in Short Message Service format, to a customer account using a phone number of the mobile device, the funds movement request including a first identifier for an account to be debited defining a bank account, a second identifier for an account to be credited defining a credit account, and a transaction amount, the text message having header data, including the phone number of an originating device,
generating a funds movement verification request in Short Message Service format, the funds movement verification request requiring customer input as a verification response,
sending the funds movement verification to the mobile device, and
authorizing the stored funds movement request from the debit account to the credit account, responsive to a receipt of the verification response.

2. A machine of claim 1, wherein the verification request includes a first one-time verification code; wherein the verification response includes a second one-time verification code; and wherein the set of instructions further includes the operations of:
generating the first one-time verification code for the stored funds movement request, and
determining whether the first one-time verification code matches the second one-time verification code to thereby confirm that the code sent by the bank server in the verification request matches the code received by the bank server in the verification response.

3. A machine of claim 2, wherein the set of instructions further includes the operations of:
notifying the customer of an invalid verification code to the phone number via a text message utilizing Short Message Service responsive to a determination that the first one-time verification code does not match the second one-time verification code to thereby prompt for a retry attempt; and
cancelling the funds movement request after a predetermined number of attempts.

4. A machine of claim 1, wherein the set of instructions further includes the operation of:
providing a customer account interface for pre-configuring a customer account, wherein pre-configuring a customer account includes associating a mobile phone number with a customer account and associating the first identifier with the debit account and the second identifier with the credit account so that the funds movement request does not use account numbers.

5. A machine of claim 1, wherein the set of instructions further includes the operations of
notifying the customer of the funds transfer using a text message generated utilizing Short Message Service to thereby present a visual representation of the funds movement.

6. A machine of claim 1, wherein the operation of storing the funds movement request further includes assigning a first time for the receiving of the funds movement request; wherein the operation of receiving a verification response includes assigning a second time for receiving the verification response; and wherein the operation of authorizing the stored funds movement request includes determining whether the second time is within a preselected time period beginning with the first time so that a verification response received after the preselected time period is untimely and invalid.

7. A computer program product operable on a bank server and stored in one or more tangible computer memory media of the bank server, the computer program product comprising a set of instructions that, when executed by the computer, cause the computer to perform a process of confirming a funds movement request is valid and a process of executing the funds movement request, the instructions comprising the operations of:
matching the funds movement request, responsive to a text message in Short Message Service format, to a customer account using a phone number of the mobile device, the funds movement request including a first identifier for an account to be debited defining a bank account, a second identifier for an account to be credited defining a credit account, and a transaction amount, the text message having header data, including the phone number of an originating device;
generating a funds movement verification request in Short Message Service format, the funds movement verification request requiring customer input as a verification response;
sending the funds movement verification to the mobile device; and
authorizing the stored funds movement request from the debit account to the credit account, responsive to a receipt of the verification response.

8. A computer program product of claim 7, wherein the verification request includes a first one-time verification code; wherein the verification response includes a second one-time verification code; and wherein the set of instructions further includes the operations of:
generating the first one-time verification code for the stored funds movement request, and
determining whether the first one-time verification code matches the second one-time verification code to thereby confirm that the code sent by the bank server in the verification request matches the code received by the bank server in the verification response.

9. A computer program product of claim 7, wherein the set of instructions further includes the operations of:
notifying the customer of an invalid verification code to the phone number via a text message utilizing Short Message Service responsive to a determination that the first one-time verification code does not match the second one-time verification code to thereby prompt for a retry attempt; and
cancelling the funds movement request after a predetermined number of attempts.

10. A computer program product of claim 7, wherein the set of instructions further includes the operation of:
providing a customer account interface for pre-configuring a customer account, wherein pre-configuring a customer account includes associating a mobile phone number with a customer account and associating the first identifier with the debit account and the second identifier with the credit account so that the funds movement request does not use account numbers.

11. A computer program product of claim 7, wherein the set of instructions further includes the operations of:
notifying the customer of the funds transfer using a text message generated utilizing Short Message Service to thereby present a visual representation of the funds movement.

12. A computer program product of claim 7, wherein the operation of storing the funds movement request further includes assigning a first time for the receiving of the funds movement request; wherein the operation of receiving a verification response includes assigning a second time for receiving the verification response; and wherein the operation of authorizing the stored funds movement request includes determining whether the second time is within a preselected time period beginning with the first time so that a verification response received after the preselected time period is untimely and invalid.

13. A computer program product of claim 7, wherein the debit account includes one or more of the following: a prepaid card account, and a deposit account; and wherein the credit account includes one or more of the following: a prepaid card account, and a deposit account.

14. A computer-implemented method to cause a computer configured as a bank server to perform a process of confirming a funds movement request is valid and a process of executing the funds movement request, the computer-implemented method comprising:
matching the funds movement request, responsive to a text message in Short Message Service format, to a customer account using a phone number of the mobile device, the funds movement request including a first identifier for an account to be debited defining a bank account, a second identifier for an account to be credited defining a credit account, and a transaction amount, the text message having header data, including the phone number of an originating device;
generating a funds movement verification request in Short Message Service format, the funds movement verification request requiring customer input as a verification response;
sending the funds movement verification to the mobile device; and
authorizing the stored funds movement request from the debit account to the credit account, responsive to a receipt of the verification response.

15. A computer-implemented method of claim 14, wherein the verification request includes a first one-time verification code; wherein the verification response includes a second one-time verification code; and the computer-implemented method further comprises:
generating the first one-time verification code for the stored funds movement request by the bank server, and
determining by the bank server whether the first one-time verification code matches the second one-time verification code to thereby confirm that the code sent by the bank server in the verification request matches the code received by the bank server in the verification response.

16. A computer-implemented method of claim 15, further comprising:
notifying the customer of an invalid verification code to the phone number via a text message utilizing Short Message Service responsive to a determination that the first one-time verification code does not match the second one-time verification code to thereby prompt for a retry attempt; and
cancelling the funds movement request after a predetermined number of attempts.

17. A computer-implemented method of claim 14, further comprising:
providing a customer account interface for pre-configuring a customer account, wherein pre-configuring a customer account includes associating a mobile phone number with a customer account and associating the first identifier with the debit account and the second identifier with the credit account so that the funds movement request does not use account numbers.

18. A computer-implemented method of claim 14, further comprising:
notifying the customer of the funds transfer using a text message generated utilizing Short Message Service to thereby present a visual representation of the funds movement.

19. A computer-implemented method of claim 14, wherein the step of storing the funds movement request by the bank server further includes assigning a first time for the receiving of the funds movement request; wherein the step of receiving by the bank server a verification response includes assigning a second time for receiving the verification response; and wherein the step of authorizing by the bank server the stored funds movement request includes determining whether the second time is within a preselected time period beginning with the first time so that a verification response received after the preselected time period is untimely and invalid.

20. A computer-implemented method of claim 14, wherein the debit account includes one or more of the following: a prepaid card account, and a deposit account; and wherein the credit account includes one or more of the following: a prepaid card account, and a deposit account.
